(19) United States
(12) Patent Application Publication
(10) Pub. No.: US 2019/0182087 A1
(43) Pub. Date: Jun. 13, 2019

(54) COMMUNICATION METHOD AND APPARATUS USING G-OFDM FOR HIGH SPEED WIRELESS COMMUNICATION

(71) Applicant: TUNITEL INC., Daejeon (KR)

(72) Inventors: Myungsup KIM, Daejeon (KR); Jinsuk SEONG, Daejeon (KR)

(21) Appl. No.: 16/084,195

(22) PCT Filed: Oct. 13, 2016
(86) PCT No.: PCT/KR2016/011505

§ 371 Date: Sep. 11, 2018

(30) Foreign Application Priority Data
Oct. 13, 2015 (KR) 10-2015-0142956
Oct. 12, 2016 (KR) 10-2016-0132351

(51) Int. Cl. H04L 27/26; H04L 5/00; G06F 17/16

(52) U.S. Cl. CPC H04L 27/264; H04L 5/0007; G06F 17/16; H04L 27/2666; H04L 5/003

(57) ABSTRACT

Provided is a communication method and apparatus using G-OFDM that dramatically improve allocation and efficiency of frequencies, by simultaneously performing a filter bank (FB) scheme intended to reduce inter-channel interference by improving an OFDM technology, which is the current fourth generation wireless communication technology, and a scheme of overlapping and multiplexing signals of a plurality of hierarchical channels on the same frequency band using hierarchical composite functions and transmitting the plurality of overlapped and multiplexed signals.

### TECHNICAL FIELD

The present invention relates to a communication method and apparatus using generalized orthogonal frequency division multiplexing (OFDM) (hereinafter, referred to as ‘G-OFDM’). The present scheme may be applied to both wired and wireless communication systems, but since the wired communication system is well known, the wireless communication system will be mainly described.

Wireless communication refers to transmitting or receiving a variety of information such as voices, images, and the like using a radio wave without using a physical wire connection. The radio wave, which is a portion of an electromagnetic wave, may transmit the information at a speed of light, and is usefully used for wireless communication because it may pass through most solids, vacuum, air, and the like. The radio wave may be divided into various bands according to a wavelength or a frequency, and is divided into a long wave, a medium wave, a short wave, and the like according to the wavelength. Specifically, the radio wave is used in different fields according to an application, and for example, an ultra high frequency (UHF) is used for TV•digital TV broadcasting and the like, a very high frequency (VHF) is used for frequency modulation (FM) radio broadcasting, TV broadcasting, a remote control unit, and the like, the short wave is used for police•aircraft radio and the like, the medium wave is used for amplitude modulation (AM) radio broadcasting, and the long wave is used for coastal•marine radio broadcasting.

Apart from the different uses of the radio wave for each wavelength, a method of using a frequency has been used so that a plurality of communications which are simultaneously performed within a use range for any one wavelength may be distinguished from each other. Specifically, when a pair of people A-B makes a phone call wirelessly, this means that voice data is transmitted between A and B using wireless communication. However, if the phone call is to be simultaneously made between the other pair of people C-D, wireless communication between A and B, and wireless communication between C and D should be distinguished from each other. In this case, the wireless communication between A and B is performed with a radio wave having a frequency of 800 MHz (for example) and the wireless communication between C and D is performed with a radio wave having a frequency of 810 MHz (for example), the wireless communication between A and B, and the wireless communication between C and D may be transmitted to be divided without being mixed with each other.

As described above, in the wireless communication, it is essential to distinguish a plurality of communications which are simultaneously performed from each other, and it is important to effectively distinguish the respective communications and to efficiently operate a large amount of simultaneous communications.

### BACKGROUND ART

As described above, in order to distinguish the plurality of communications which are simultaneously performed in wireless communication, a method of appropriately dividing and allocating frequency bands has been used, and in the past when wireless communication usage itself was not large, even if the frequency bands were divided and allocated in a very simple manner as in the example described above, there is no significant problem. However, as a trend of generalization of wireless communication rapidly increases and the number of wireless telephone users also increases exponentially, a research has been steadily conducted to more efficiently distribute and allocate the frequency bands.

Examples of a frequency division scheme include Frequency Division Multiple Access (FDMA), Time Division Multiple Access (TDMA), Code Division Multiple Access (CDMA), and OFDM as the most recent scheme. FDMA is a frequency division scheme that was used first and literally divides and allocates the frequency bands for each of the users. However, in such a scheme, as the number of simultaneous users increases, the frequency band that may be allocated becomes narrow, there is a big problem that noise is increased and quality of communication is deteriorated. A scheme proposed to solve the above-mentioned problem is TDMA, which is called so-called 2G in a wireless phone market. In TDMA, one user uses all of the frequency bands at a time, but when the number of users increases, a plurality of users alternately use the all of the frequency band (i.e., with a time difference). Meanwhile, CDMA developed and used in the same time period as TDMA and developed more than TDMA is called 3G. In CDMA, all users use all of the frequency bands at the same time at all times, but signals of the respective users are distinguished by performing multiplexing using random numbers allocated for each of the users.

OFDM is a technology that makes these existing technologies more efficient, and is called OFDM-TDMA, OFDM-CDMA, and the like depending on whether it is combined with any technology. OFDM is a frequency-orthogonal technology, and carries data which is divided into a plurality of pieces on carrier frequencies of a predetermined interval which are orthogonal to each other to simultaneously transmit it. In the case of the FDMA scheme, some margin should be given between the frequency bands used for actual communication to avoid interference between adjacent frequencies, but when the OFDM scheme is applied, since interference does not occur in a case in which frequencies are orthogonal to each other even though the frequencies are overlapped, the above-mentioned margin needs not to be given and the frequency bands are more efficiently allocated and distributed. Several detailed technologies utilizing such OFDM are disclosed in Korean Patent Laid-Open Publication No. 2006-0116019 (“METHOD AND APPARATUS FOR OVERLAYING MULTI-CARRIER AND DIRECT SEQUENCE SPREAD SPECTRUM SIGNALS IN A BROADBAND WIRELESS COMMUNICATION SYSTEM” published on Nov. 13, 2006), Korean Patent Laid-Open Publication No. 2008-0090031 (“APPARATUS AND METHOD FOR TRANSMISSION IN OFDM COMMUNICATION SYSTEM” published on Oct. 8, 2008), and the like. Since the OFDM scheme is efficient in allocating the frequency bands and has strong multipath characteristics of radio waves, it is now actively used.

Meanwhile, in a conventional OFDM transmission scheme, a guard interval (GI) is inserted to remove inter-symbol interference due to the multipath, and if there is no signal in a GI section, orthogonality of subcarriers may collapse, which cause inter-channel interference. In order to prevent the above-mentioned problem, a portion of a signal of a back part of a symbol section is copied and inserted and this signal is cyclic prefix (CP). However, this CP is a factor that actually reduces transmission efficiency, and in this scheme, a signal level between neighboring channels has only a difference of 13.6 dB, which causes interference to the neighboring channels. Further, since this scheme also causes interference to neighboring frequency bands, guard bands are used in frequency use, which deteriorates efficiency of the frequency use.

A technology proposed to solve the above-mentioned disadvantage is a filter bank multicarrier (FBMC) technology, which has advantages in that it does not cause interference to neighboring channels except for a minimum transmission band, it leads to very little leakage power between bands, and it does not need to use CP. As a result, the frequency may be more efficiently used. Detailed contents for OFDM and FBMC, and comparison between the respective techniques and advantage and disadvantage thereof are introduced in detail in “Filter Bank Multicarrier (FBMC) transmission technology trend” (Korea Communication Agency, Broadcasting & Telecommunications Technology Issue & Outlook, No. 61, 2014, Mar. 3, 2014). However, on the other hand, since FBMC technology has a very large prototype filter and a very large implementation complexity, it has a problem that when it is implemented as a device, it causes a large amount of power consumption and is not suitable for commercialization.

An amount of usage of wireless communication is expected to increase exponentially in the future, and it is predicted that even if several schemes as described above are used, the amount of usage thereof may not be sufficiently covered. Therefore, it is required to develop a scheme for more efficiently using frequencies.

### RELATED ART DOCUMENT

### Patent Document

a. Korean Patent Laid-Open Publication No. 2006-0116019 (“METHOD AND APPARATUS FOR OVERLAYING MULTI-CARRIER AND DIRECT SEQUENCE SPREAD SPECTRUM SIGNALS IN A BROADBAND WIRELESS COMMUNICATION SYSTEM” published on Nov. 13, 2006)
b. Korean Patent Laid-Open Publication No. 2008-0090031 (“APPARATUS AND METHOD FOR TRANSMISSION IN OFDM COMMUNICATION SYSTEM” published on Oct. 8, 2008)

### Non-Patent Document

c. “Filter Bank Multicarrier (FBMC) transmission technology trend” (Korea Communication Agency, Broadcasting & Telecommunications Technology Issue & Outlook, No. 61, 2014, Mar. 3, 2014)

### DISCLOSURE

### Technical Solution

In one general aspect, there is provided a communication method using generalized orthogonal frequency division multiplexing (G-OFDM), wherein a plurality of hierarchical channels defined as predetermined frequency bands are present and digital data is carried in each of the hierarchical channels, the plurality of hierarchical channels are overlapped and multiplexed by a plurality of hierarchical composite functions that each correspond to the plurality of hierarchical channels, are defined as functions in a frequency domain, and have orthogonality and frequency cut-off characteristic, such that transmission and reception are performed, and each of the hierarchical channel is divided into a plurality of subchannels. The respective frequency bands of the plurality of subchannels formed for each of the hierarchical channel may be formed to be equal to each other (i.e., physically and fully overlapped) for all hierarchical channels.

When it is assumed that a matrix including the plurality of hierarchical composite functions is a composite matrix and a matrix including hierarchical split functions that each correspond to the plurality of hierarchical composite functions is a split matrix, the composite matrix and the split matrix may be represented by a hierarchical function matrix G having the same structure, and the hierarchical function matrix C may be formed so that G^{T}G=I is established.

G^{T}G=I

The obtaining of the hierarchical function matrix G may include: determining an initial matrix G_{D} as a matrix having a length of a column of 1 and having orthogonality between columns; multiplying a jump removal matrix θ with the initial matrix G₀ to have frequency cut-off characteristic by preventing an occurrence of a spectrum spreading or leakage phenomenon due to a jump at a start point, wherein the jump removal matrix performing an operation of subtracting a first row from each row; multiplying a filtering matrix Ω with a product θG₀ of the jump removal matrix θ and the initial matrix G₀ to perform a column smoothing; and generating the hierarchical function matrix G by transforming a product ΩθG₀ of the filtering matrix Ω, the jump removal matrix θ, and the initial matrix G₀ by a transformation function (f( )) to re-secure orthogonality.

$$G = f ( ΩΘ {G}_{0} ) , f ( X ) = {S ( {X}^{H} X )}^{- \frac{1}{2}}$$

A first column of a hierarchical function matrix G_{p,e1} generated with an initial matrix G_{p,o}⁽⁰⁾ and a jump matrix R_{p,e1} that have a length of an even-numbered column, or a hierarchical function matrix G_{p,o1} generated with an initial matrix G_{p,o}⁽⁰⁾ and a jump matrix R_{p,o1} that have a length of an odd-numbered column may be used as a pilot vector, wherein the initial matrix G_{p,o}⁽⁰⁾ having the length of the even-numbered column may be defined as

$${G}_{p , e}^{( 0 )} = \frac{1}{\sqrt{2}} [ \begin{matrix} & & & & & 1 & 1 \\ & & & & ⋰ & & \\ & & 1 & 1 & & & \\ & 1 & & & & & \\ 1 & & & & & & \\ - 1 & & & & & & \\ & - 1 & & & & & \\ & & 1 & - 1 & & & \\ & & & & ⋱ & & \\ & & & & & 1 & - 1\end{matrix} ] ,$$

the jump matrix R_{p,e1} having the length of the even-numbered column may be defined as

$${R}_{p , e 1} = \frac{1}{\sqrt{2}} [ \begin{matrix} & & & & & & 0 \\ & & & & 0 & 1 & \\ & & & ⋰ & & & \\ & 0 & 1 & & & & \\ 0 & & & & & & \\ 0 & & & & & & \\ & 0 & 1 & & & & \\ & & & ⋱ & & & \\ & & & & 0 & 1 & \\ & & & & & & 0\end{matrix} ] ,$$

the initial matrix G_{p,o}⁽⁰⁾ having the length of the odd-numbered column may be defined as

$${G}_{p , o}^{( 0 )} = \frac{1}{\sqrt{2}} [ \begin{matrix} & & & & 1 & 1 \\ & & & ⋰ & & \\ & 1 & 1 & & & \\ 1 & & & & & \\ 0 & & & ⋯ & 0 & 0 \\ - 1 & & & & & \\ & 1 & - 1 & & & \\ & & & ⋱ & & \\ & & & & 1 & - 1\end{matrix} ] ,$$

and
the jump matrix R_{p,o1} having the length of the odd-numbered column may be defined as

$${R}_{p , o 1} = \frac{1}{\sqrt{2}} [ \begin{matrix} & & & & 0 & 0 \\ & & & ⋰ & & \\ & & & & & \\ 0 & 2 & 0 & ⋯ & 2 & 0 \\ & & & & & \\ & & & ⋱ & & \\ & & & & 0 & 0\end{matrix} ] .$$

The communication method may include overlapping and transmitting frequencies in which data consisting of digital signals is converted into a waveform signal and is transmitted through the plurality of hierarchical channels, and the data carried in the hierarchical channels is overlapped in the frequency domain using the hierarchical composite functions, is converted into a time domain signal and is then transmitted to one communication channel; and splitting and receiving the frequency in which the data of a form of the analog signal transmitted by the overlapping and transmitting of the frequencies is received and is converted to the frequency domain signal from a time domain signal, and the data consisting of the digital signals carried in each of the hierarchical channels is split and restored using hierarchical split functions corresponding to the hierarchical composite functions.

The communication method may use one modulation scheme selected from BPSK, QPSK, M-PSK, and M-QAM (where M=2N, N=1, 2, 3, . . . ) when the data is carried in each of the subchannels, and the modulation schemes used for each of the hierarchical channels may be the same as or different from each other.

A communication apparatus using G-OFDM performs communication using a communication method as described above.

### Advantageous Effects

According to the present invention, the inter-channel interference may be dramatically reduced by overlapping the frequency bands and using the overlapped frequency band. More specifically, unlike the related art in which a method of converting a digital symbol into a waveform signal using a modulation technology through a communication channel during data communication is used, according to the present invention, the transmission side forms and overlaps symbols of a plurality of hierarchical channels in a frequency domain using a hierarchical composite function and transmits the formed and overlapped symbol, and the reception side separates original symbols of the hierarchical channels from the overlapped signal using a hierarchical separation function. Accordingly, unlike the related art in which one eigen frequency band needs to be allocated for one user, when G-OFDM according to the present invention is used, the data symbols are overlapped and are transmitted, thereby making it possible to efficiently reduce frequency interference. In the case of Faster than Nyquist (FTN), which is currently being studied actively, since it is very difficult to achieve synchronization between transmission and reception due to severe inter-symbol interference and it uses error correction code having high computation to mitigate interference, system implementation complexity is high, but since the technology according to the present invention overlaps the symbols using the function having separable properties (e.g., orthogonality), it is incomparably simpler than the FTN technology and also has a great advantage that an implementation or operation of the system is much easier and economical. Of course, a large number of functions having synthesizable and analyzable properties may be generated within a mathematically finite interval, but the number of functions when technically implemented needs to be appropriately limited according to the complexity.

That is, according to the present invention, since the existing frequency interference problem may be perfectly solved by using the G-OFDM technology, the G-OFDM technology is expected to be a very useful technology for the next generation communication technology as well as the fifth generation.

### DESCRIPTION OF DRAWINGS

FIG. 1 illustrates a conventional OFDM communication scheme principle

FIG. 2 illustrates a case in which two hierarchical channels are overlapped and divided using a G-OFDM scheme according to the present invention.

FIG. 3 illustrates a case in which a plurality of hierarchical channels composed of one subchannel are combined and divided using the G-OFDM scheme according to the present invention.

FIG. 4 illustrates a communication scheme principle using the G-OFDM scheme according to the present invention.

FIG. 5 illustrates oversampling.

FIG. 6 illustrates a transmitter structure that implements a step of overlapping and transmitting frequencies.

FIG. 7 illustrates a receiver structure that implements a step of separating and receiving the frequencies.

FIG. 8 illustrates a structure of a transmitter and a receiver using the G-OFDM scheme according to the present invention.

FIG. 9 illustrates a process of generating a hierarchical function matrix having orthogonality and frequency cut-off property.

FIG. 10 illustrates a set of hierarchical composite functions in a time domain of G(8,6)-OFDM.

FIG. 11 illustrates frequency response characteristic of hierarchical composite functions of G(8,6)-OFDM.

FIG. 12 illustrates density of a power frequency including hierarchical composite functions of OFDM and G(8,6)-OFDM.

FIG. 13 illustrates a set of hierarchical composite functions in a time domain of G(7,5)-OFDM.

FIG. 14 illustrates frequency response characteristic of hierarchical composite functions of G(7,5)-OFDM.

FIG. 15 illustrates density of a power frequency including hierarchical composite functions of OFDM and G(7,5)-OFDM.

### BEST MODE

Hereinafter, a communication method and apparatus using G-OFDM according to the present invention having the configuration as described above will be described in detail with reference to the accompanying drawings.

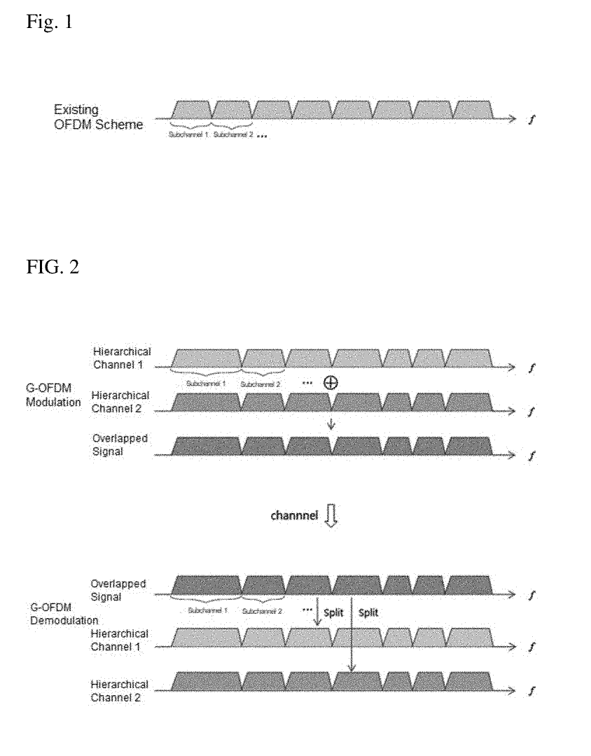

FIG. 1 conceptually illustrates a conventional OFDM communication scheme principle. It was already described that a single user uses the frequency f of all bands in the existing TDMA(2G), CDMA(3G), and the like. On the other hand, in the OFDM scheme, the allocated frequency band is divided into subchannels (indicated as ‘subchannel 1, subchannel 2, . . . ’ on FIG. 1) including a plurality of small frequency bands, and the data is divided to be transmitted and received, as illustrated in FIG. 1, instead of carrying and communicating one signal in the entire frequency band. In this case, one subchannel is occupied by one information symbol. That is, referring to FIG. 1, wireless communication is performed such that a symbol 1 transmits and receives the data using a frequency of the subchannel 1, a symbol 2 transmits and receives the data using a frequency of the subchannel 2, and the like.

Here, the symbol refers to a minimum unit of data which is transmitted at a time in data communication. For example, in the case of 4-PSK modulation, the symbol may be transmitted in four forms of 1, j, −1, and −j at a time. In this case, information corresponding to 2 bits may be transmitted at a time, and as a result, the symbol may be regarded to be approximately equal to 2 bits. Examples of the modulation scheme include BPSK, QPSK, M-PSK, M-QAM, and the like, and since above-mentioned modulation schemes are well known, a detailed description thereof will be omitted.

Conventionally, the data is transmitted and received by carrying the data in one channel including the plurality of subchannels. That is, according to the conventional scheme, only one information symbol may be carried in one subchannel. On the other hand, according to the present invention, a plurality of hierarchical channels including a plurality of subchannels are overlapped by using a hierarchical composite function in a frequency domain. That is, a plurality of information symbols may be carried in one subchannel by overlapping the plurality of hierarchical channels, thereby making it possible to significantly reduce frequency interference as compared to the conventional scheme. An overlapping scheme according to the present invention as described above is referred to as ‘generalized orthogonal frequency division multiplexing (G-OFDM).

FIG. 2 illustrates a case in which two hierarchical channels are overlapped and divided using a G-OFDM scheme according to the present invention. It is the same to use the entire frequency band by dividing it into small bands of subchannel 1, subchannel 2, . . . , but the subchannels herein do not need to have the same size range as each other. Accordingly, FIG. 2 illustrates an example in which sizes of the subchannels are different from each other. According to the present invention, a signal in which a symbol of a hierarchical channel 1 is carried in the subchannel 1 and a signal in which a symbol of a hierarchical channel 2 is carried in the subchannel 2 are overlapped using the hierarchical composite function in the frequency domain. As a result, an overlapped symbol 1 is carried in the subchannel 1 and is transmitted. That is, in the transmitted signal, the overlapped symbol 1 is carried in the subchannel 1, an overlapped symbol 2 is carried in the subchannel 2, and so on. A receiving side receives overlapped symbols through a process of receiving the overlapped symbol 1 through the subchannel 1, receiving the overlapped symbol 2 through the subchannel 2, and so on, and may obtain original symbols by splitting the original symbols through a process of obtaining a symbol 11 and a symbol 21 by splitting the overlapped symbol 1, and so on using the hierarchical split function for each of the subchannels.

That is, according to the present invention, unlike the conventional case in which only symbol may be carried in one subchannel and transmitted, a plurality of symbols may be overlapped and carried in one band and transmitted by overlapping and splitting the information symbol signal using the hierarchical composite and analytic functions in the frequency domain. Accordingly, according to the present invention, the same frequency band may be efficiently controlled, thereby making it possible to significantly reduce interference. As described above, the wireless communication method according to the present invention may contribute to substantially increase communication capacity by reducing frequency interference between systems.

The wireless communication method according to the present invention as described above is conceptually summarized as follows. In the wireless communication method according to the present invention, a plurality of hierarchical channels defined as predetermined frequency bands exist, such that digital data is carried in each of the hierarchical channels, and the plurality of hierarchical channels are overlapped and multiplexed by a plurality of hierarchical composite functions corresponding to the plurality of hierarchical channels, respectively, and defined as the function in the frequency domain, thereby performing transmission and reception. In this case, the respective hierarchical channels are divided into a plurality of subchannels such that the data may be more efficiently carried. In this case, the respective frequency bands of the plurality of subchannels formed for each of the hierarchical channels are formed to be same as each other for all of the hierarchical channels. Accordingly, as described above, unlike the conventional case in which only one information symbol is carried in one subchannel and transmitted and received, according to the present invention, information symbols corresponding to the number of hierarchical channels may be carried in one subchannel and transmitted and received.

The wireless communication method according to the present invention as described above will be described in more detail. The wireless communication method according to the present invention includes a step of overlapping and transmitting frequencies and a step of splitting and receiving the frequency.

In the step of overlapping and transmitting the frequencies, data consisting of digital signals is converted into an analog signal and is transmitted through the plurality of hierarchical channels (here, the hierarchical channels are defined as predetermined frequency bands and include the plurality of subchannels as illustrated, and the entire band and bands of the respective subchannels are equal to each other for each of the hierarchical channels). In this case, the data carried in the respective hierarchical channels is overlapped in the frequency domain and is converted into a time domain signal using the hierarchical channel composite functions, and is then transmitted to one communication channel.

In the step of splitting and receiving the frequency, the data of the form of the analog signal transmitted by the step of overlapping and transmitting the frequencies is received and is then converted into a frequency domain signal from the time domain signal, and the data of the digital signal carried in each of the hierarchical channels is split and restored using the hierarchical split functions corresponding to the hierarchical composite functions.

Hereinafter, a frequency overlapping principle, which is a main principle of the present invention, will be first described, and a detailed example in which the frequency overlapping principle is actually applied to a digital communication system will be then described.

Frequency Overlapping Principle

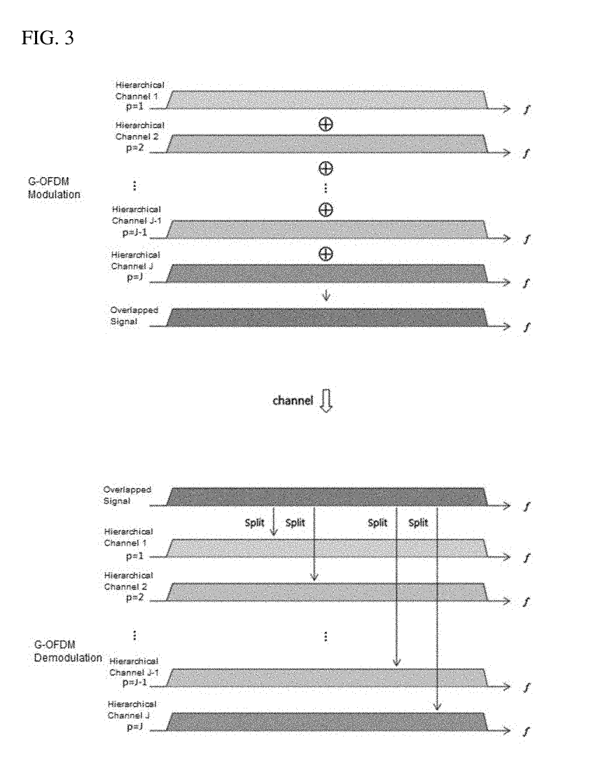

FIG. 3 conceptually illustrates a principle of transmitting and receiving information symbols of a plurality of hierarchical channels to one subchannel using a G-OFDM scheme according to the present invention.

Here, as an example of the hierarchical composite function to describe a principle of the present invention, an orthogonal waveform will be described by way of example. In a frequency domain, an orthogonal function has the following property.

$${\int }_{- B 2}^{B 2} {H}_{p} ( f ) {H}_{q} ( f ) df = \{ \begin{matrix}E , & p = q \\ 0 , & p \neq q\end{matrix} \qquad ( 1 )$$

Here, Hₚ(ƒ) and the like denote pulses in the frequency domain, B denotes a bandwidth of all Hₚ(ƒ), and E denotes a real number. When an information symbol is sₚ, J information symbols may be combined as follows.

$$U ( f ) = {\sum }_{p = 0}^{J - 1} {s}_{p} {H}_{p} ( f ) \qquad ( 2 )$$

A signal J of the frequency domain formed by overlapping the sₚ information symbols U(ƒ) may be expressed as follows through an inverse Fourier transform.

$$\begin{matrix}u ( t ) = {F}^{- 1} \{ U ( f ) \} \\ = {\sum }_{p = 0}^{J - 1} {s}_{p} {h}_{p} ( t )\end{matrix} \qquad ( 3 )$$

Actually, a signal u(t) expressed in Equation (3) is transmitted through a communication channel. That is, the information symbol sₚ is carried in Hₚ(ƒ), which is a pulse in a time domain corresponding to hₚ(t), which is a pulse in the frequency domain, and is transmitted. However, in a case in which channel noise is introduced into the above-mentioned signal, the signal may be expressed as follows.

r(t)=u(t)+n(t) (4)

Here, n(t) is a noise signal. In order to extract the information symbol from the above-mentioned signal, the following procedures are performed. First, the signal r(t) is Fourier-transformed as follows.

$$\begin{matrix}R ( f ) = F \{ r ( t ) \} \\ = U ( f ) + N ( f )\end{matrix} \qquad ( 5 )$$

Integration is performed by a R(ƒ)-th pulse for the Fourier-transformed signal p in the frequency domain as follows.

$$\begin{matrix}{v}_{p} = {\int }_{- B 2}^{B 2} R ( f ) {H}_{p} ( f ) df \\ = {\int }_{- B 2}^{B 2} [ {\sum }_{p = 0}^{J - 1} {s}_{p} {H}_{p} ( f ) + N ( f ) ] {H}_{p} ( f ) df \\ = {Es}_{p} + {n}_{p}\end{matrix} \qquad ( 6 )$$

Here, nₚ is a noise component introduced into a p-th channel. An estimation of the information symbol sₚ is performed as follows.

$${\hat{s}}_{p} = dec \{ \frac{1}{E} {v}_{p} \} \qquad ( 7 )$$

Here, dec{⋅} is logic that determines the information symbol. By performing the procedures as described above, even if the frequencies are overlapped and transmitted, the principle capable of receiving the information has been shown.

### Applying Frequency Overlapping Principle to Digital Communication System

In the description of the frequency overlapping principle above, the principle in which the information symbols of the plurality of hierarchical channels are transmitted to one subchannel has been described. However, in order to practice the frequency overlapping principle, much more information symbols need to be transmitted. To this end, as illustrated in FIG. 2, a plurality of hierarchical channels are overlapped using the hierarchical composite functions and a plurality of subchannels are placed in one hierarchical channel, thereby transmitting a larger amount of data.

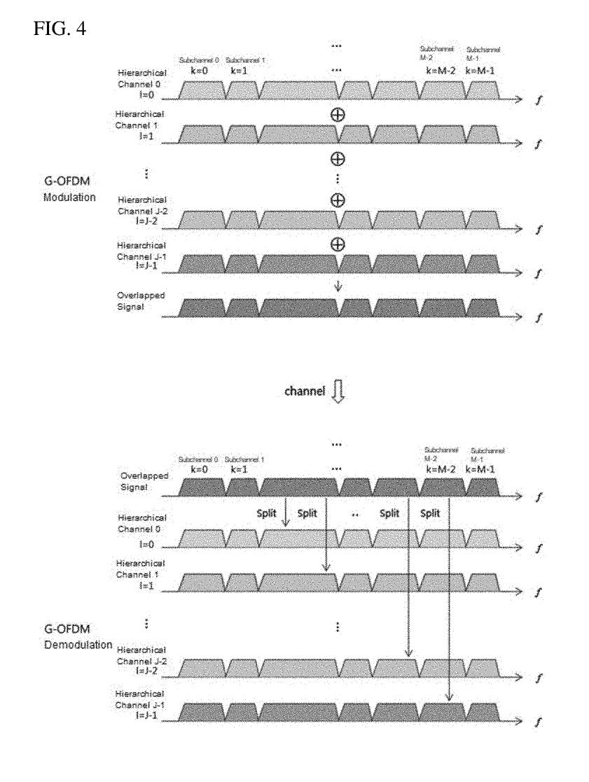

FIG. 4 conceptually illustrates a principle of transmitting a large amount of data to a channel having a plurality of subchannels using G-OFDM scheme according to the present invention. A detailed example for applying the respective steps (the step of overlapping and transmitting the frequencies and the step of splitting and receiving the frequency) of the wireless communication method according to the present invention will be described in more detail with reference to FIG. 4.

### Step of Overlapping, Multiplexing and Transmitting Frequencies

First, an input data column dₗ(k) of a digital form to be transmitted is indexed to each of the hierarchical channels l and the subchannels k by a symbol mapper, and corresponds to a symbol uₗ(k) on a complex number plane. This will be described in detail as follows. In the digital communication system, data to be transmitted has a digital form. Such an input data column dₗ(k) is modulated through a baseband modulator, which is called the symbol mapper. As a modulation scheme, all baseband digital modulation schemes such as BPSK, QPSK, M-PSK, M-QAM, and the like may be applied. A symbol mapping for a k-th hierarchical channel and a k-th subchannel may be expressed as follows.

C:d(k)→sₗ(k), k=0,1,2, . . . ,M−1, l=0,1,2 . . . ,J−1 (8)

The symbol mapping serves to map a data bit collection k carried in the dₗ(k)-th subchannel to a symbol uₗ(k) on the complex number plane.

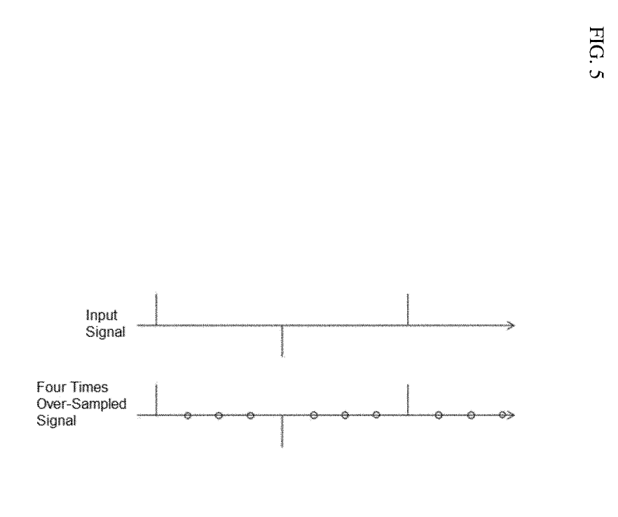

Next, the symbol uₗ(k) of each channel is over-sampled N times and is transformed into an over-sampled signal xₗ(k). N The N−1 times over-sampling may be implemented by inserting N−1 zeros between symbols. FIG. 5 illustrates an example of the over-sampling in which N is 4.

Next, the over-sampled signal xₗ(k) of each of the hierarchical channel is convoluted by an orthogonal function hₗ(k) in the frequency domain and is formed as formation signal yₗ(k). In this case, the number of orthogonal functions hₗ(k) is equal to the number of hierarchical channels, and the orthogonal function hₗ(k) in the present exemplary embodiment corresponds to the hierarchical composite function in the previous principle description. In other word, as described above, if the hierarchical overlapping and splitting may be made, any function may be used as the hierarchical composite function, but since the orthogonal function may be easily implemented most intuitively, the orthogonal function is merely used in the present exemplary embodiment and the hierarchical composite function other than the orthogonal function may also be applied if necessary. A condition of the hierarchical composite function is that a function expressed by a product of the composite function and the analytic function has orthogonality when the hierarchical analytic function is used to split the hierarchical channel later.

yₗ(k)=(xₗ(k)*hₗ(k))_{LN} (9)

As described above, the over-sampled signal xₗ(k) formed in the frequency domain, that is, the formation signal yₗ(k) may be split for each of the channels at a receiving stage by a hierarchical split function to be described below by using orthogonality with the hierarchical composite function in a neighboring channel.

A convolution process of the over-sampled signal xₗ(k) and the orthogonal function hₗ(k) in the frequency domain will be described in more detail as follows. First, the hierarchical composite function may be expressed as in Equation (10).

$${H}_{l} ( z ) = {\sum }_{k = 0}^{M - 1} {h}_{l} ( k ) {z}^{- k} , 0 \leq l \leq J - 1 \qquad ( 10 )$$

In addition, a formation filtering by the hierarchical composite function means that a convolution is circulative so that a total sample length becomes L by a length N of an input data vector and a parameter LN, and the circulating convolution is calculated as follows.

\tilde{y}ₗ(k)=xₗ(k)*hₗ(k) (11)

A length of \tilde{y}ₗ(k) obtained by doing so is MN+L−1. \tilde{y}ₗ(k) The circulating convolution may be obtained by overlapping as follows.

yₗ=\tilde{y}ₗ[((L+1)/2),\tilde{y}ₗ(L+1)/2+1),\tilde{y}ₗ((L+1)/2+2), . . . ,\tilde{y}(ₗ(L+1)/2+MN−1)]+[0,0,0, . . . ,0,\tilde{y}ₗ(0),\tilde{y}ₗ(1),\tilde{y}ₗ(2), . . . ,\tilde{y}ₗ((L+1)/2−1)] (12)

Next, the formation signals yₗ(k) of the respective hierarchical channels are added element by element and are vector-mixed, and are thereby overlapped to one overlapped signal w. This operation may be expressed as follows.

w=y₀+y₁+ . . . +y_{J-1} (13)

Equation (13) represents that all outputs of the J hierarchical channels are added.

Next, the overlapped signal w is transformed from the frequency domain signal to the time domain signal by an inverse Fourier transform and becomes a transmitted signal s of an analog signal form.

s=F⁻¹(w) (14)

In Equation (14), F⁻¹ denotes an inverse Fourier transform operator.

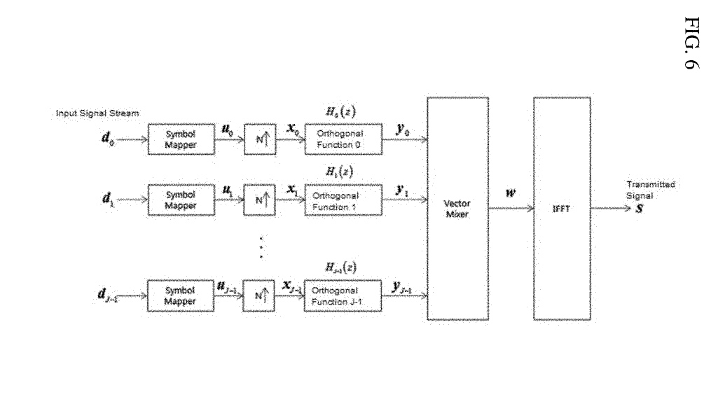

Finally, the transmitted signal s, which is the analog signal of the time domain is transmitted to one communication channel. FIG. 6 illustrates a structure of a transmitter that implements the step of overlapping and transmitting the frequencies as described above.

### Step of Splitting and Receiving Frequency

First, the received signal s in which the transmitted signal n transmitted through the communication channel and the noise signal r introduced into the communication channel are summed is received (see Equation (15)). Ideally, although the transmitted signal transmitted in the step of overlapping and transmitting the frequencies should be received as it is, noise is necessarily introduced into the transmitted signal in an actual communication environment. In consideration of the above-mentioned point, it is assumed that the received signal includes not only the transmitted signal but also the noise signal. As shown in Equation (15), the transmitted signal s, the noise signal n, and the received signal r are all expressed by a vector form.

r=s+n (15)

Next, the received signal r is transformed from the time domain signal to the frequency domain signal by a fast Fourier transform (FFT), and becomes a transformed signal b. Such an operation will be expressed as follows.

b=F(r) (16)

Next, the transformed signal b is convoluted by the hierarchical split function gᵢ(k) in the frequency domain and is split into a split signal pᵢ(k) for each of the hierarchical channels, which is a form of a digital signal.

pₗ(k)=(b(k)*gₗ(k))_{LN} (17)

The hierarchical split function corresponds to the hierarchical composite function which is used in the step of overlapping the frequencies, and is determined so that the function expressed by the product of the composite function and the analytic function has orthogonality as described above. That is, a relationship between a composite function h and an analytic function g is as follows.

$${\sum }_{k = 0}^{M - 1} {h}_{i} ( k ) {g}_{j} ( k ) = \{ \begin{matrix}E & i = j \\ 0 & i \neq j\end{matrix} \qquad ( 18 )$$

Next, a signal pᵢ(k) before transform, which is a signal of a point at which the magnitude of the signal is maximum is obtained for every N signals from the split signal N. That is, the N times over-sampled signal in the step of overlapping and transmitting the frequencies above is returned to an original form.

q(k)=p(kN) k=0,1,2, . . . ,N−1 (19)

Next, the output data column q(k) for each of the hierarchical channels is restored by applying symbol determination logic dec{⋅} to the signal \hat{d}ᵢ(k) before transform.

\hat{d}ᵢ(k)=dec{q(k)}, k=0,1,2, . . . ,N−1 (20)

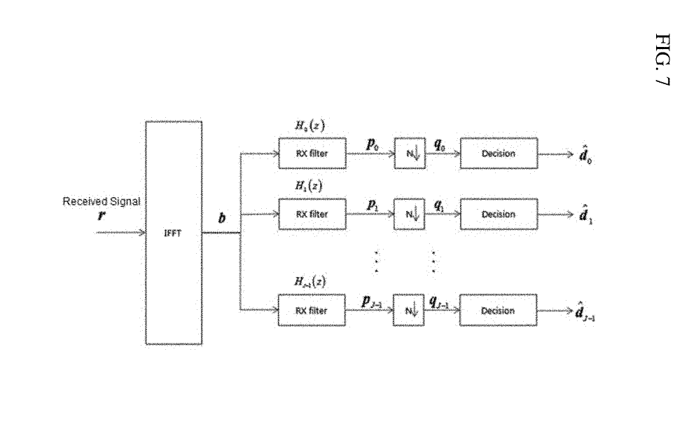

FIG. 7 illustrates a structure of a receiver that implements the step of splitting and receiving the frequency as described above.

### Example of Generating Hierarchical Composite Function and Hierarchical Split Function

As described above, in the wireless communication method according to the present invention, data for each of the hierarchical channels is overlapped in the frequency domain using the hierarchical composite functions. Such hierarchical composite functions are waveforms having property (e.g., orthogonality) that they may be split from each other and has excellent frequency cut-off characteristic. As an example, since the Hadamard matrix has excellent orthogonality, but has no frequency cut-off characteristic, it is unsuitable for application to the communication method according to the present invention.

The present invention will propose new hierarchical composite function and hierarchical split function that simultaneously satisfy orthogonality and frequency cut-off characteristic. An example of forming the above-mentioned function will be described below, but since it is not very effective to list the hierarchical function one by one, orthogonality and frequency cut-off characteristic of each column will be discussed by introducing a matrix.

G^{T}G=1 (21)

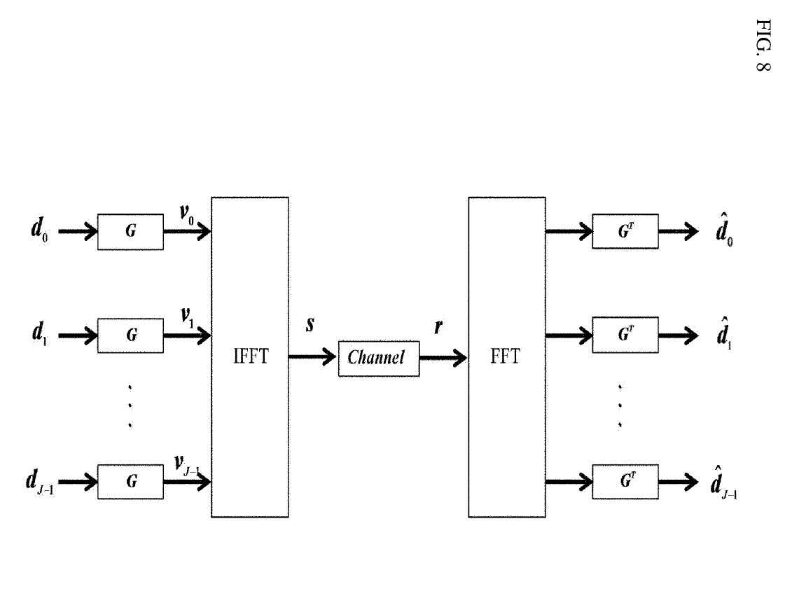

A process of forming a matrix G of the hierarchical functions is shown in FIG. 9. Structures of a composite matrix and a split matrix are equal to each other. The matrix G of the hierarchical functions is obtained by Equation below.

G=f(ΩθG₀) (22)

Here, G₀ is an initial matrix, θ is a matrix for removing a jump, Ω and is a filtering matrix for column smoothing of the matrix. The respective functions may be expressed by Equations below.

$$\begin{matrix}Ω = {W}^{T} F Ψ {F}^{- 1} W & ( 23 a ) \\ Θ = {W}^{T} F Φ {F}^{- 1} W & ( 23 b ) \\ f ( X ) = {X ( {X}^{H} X )}^{- \frac{1}{2}} & ( 23 c )\end{matrix}$$

Matrixes F⁻¹W and W^{T}F are matrixes transformed from the frequency domain to the time domain, and from the time domain to the frequency domain, respectively. Matrixes Φ and Ψ perform a function of removing a jump in the columns in the matrix and a filtering function in the time domain, respectively.

Hereinafter, it will be more detail described that a process of deriving the matrix G₀ of the hierarchical function starting with the initial matrix G is finally shown as in Equation (22).

The initial matrix G₀ is related to a length of the column necessary to transmit the data, and a shape thereof is different when it is an even number and an odd number. A common characteristic is that the length of the column is 1 and the respective columns are orthogonal to each other.

When, the length of the column is the even number, that is, N is the even number, the initial matrix has a shape below.

$${G}_{e}^{( 0 )} = \frac{1}{\sqrt{2}} [ \begin{matrix} & & & & & & 1 & 1 \\ & & & & & ⋰ & & \\ & & & 1 & 1 & & & \\ & 1 & 1 & & & & & \\ 1 & & & & & & & \\ - 1 & & & & & & & \\ & 1 & - 1 & & & & & \\ & & & 1 & - 1 & & & \\ & & & & & ⋱ & & \\ & & & & & & 1 & - 1\end{matrix} ] \qquad ( 24 )$$

When, the length of the column is the odd number, that is, N is the odd number, the initial matrix has a shape below.

$${G}_{o}^{( 0 )} = \frac{1}{\sqrt{2}} [ \begin{matrix} & & & & & 1 & 1 \\ & & & & ⋰ & & \\ & & 1 & 1 & & & \\ 1 & 1 & & & & & \\ 0 & 0 & & & … & 0 & 0 \\ 1 & - 1 & & & & & \\ & & 1 & - 1 & & & \\ & & & & ⋱ & & \\ & & & & & 1 & - 1\end{matrix} ] \qquad ( 25 )$$

In addition, as seen in Equations (24) and (25), most of the elements of the matrix are zero, which means that there are operations with other matrices, an object of the operation is achieved with minimal operation. Space portions are 0, and a center row of Equation 25 is all 0s.

Now, it is necessary to process such a matrix G₀ to have the desired property, but it is not easy to have intuitive force in the frequency domain. This is because it is familiar with signal processing in the time domain rather than in the frequency domain. Therefore, G₀ is first switched to the time domain.

G₀ In order to switch G₀ to the time domain, the columns of the matrix are expanded to a required size and are zero-padded, and in this case, a matrix required for permuting and zero-padding is defined as follows.

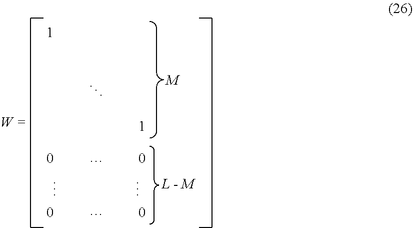

G₀ A matrix in which G₀ is permuted and zero-padded may be expressed as follows.

A₁=WG₀ (27)

In order to switch the matrix A₁ to the time domain, IFFT is performed for each column as follows.

P₁=F⁻¹A₁ (28)

Here, F is expressed in as Equation (29) and θ=2π/L.

$$F = [ \begin{matrix}1 & 1 & 1 & … & 1 \\ 1 & {e}^{- j θ} & {e}^{- j 2 θ} & … & {e}^{- j ( L - 1 ) θ} \\ 1 & {e}^{- j 2 θ} & {e}^{- j 4 θ} & … & {e}^{- j 2 ( L - 1 ) θ} \\ ⋮ & ⋮ & ⋮ & ⋮ & ⋮ \\ 1 & {e}^{- j ( L - 1 ) θ} & {e}^{- j 2 ( L - 1 ) θ} & … & {e}^{- j ( L - 1 ) ( L - 1 ) θ}\end{matrix} ] \qquad ( 29 )$$

Since a first row of the matrix F is all is, a first row the matrix transformed by IDFT may be written as follows.

$${p}_{1} = [ \begin{matrix}{\sum }_{l = 0}^{L - 1} {a}_{l , 1} & {\sum }_{l = 0}^{L - 1} {a}_{l , 2} & … & {\sum }_{l = 0}^{L - 1} {a}_{l , M}\end{matrix} ] \qquad ( 30 )$$

The reason for a spectrum spread phenomenon in OFDM is that each carrier function has a sudden jump at a starting point. In other words, a spectrum spread or leakage phenomenon occurs due to the jump including a large amount of high frequency at the start point. Therefore, such a jump may be removed by subtracting the first row from each row. This is mathematically expressed as follows.

$${Q}_{1} = Φ {P}_{1} = [ \begin{matrix}{p}_{1} \\ ⋮ \\ {p}_{L}\end{matrix} ] - [ \begin{matrix}{p}_{1} \\ ⋮ \\ {p}_{1}\end{matrix} ] = P - {J}_{P} \qquad ( 31 )$$

Here, Φ serves as an operator that removes the jump from the columns of the matrix P₁. Q₁ The matrix may be transformed to the frequency domain by performing DFT for the columns of Q₁. This may be mathematically expressed as follows.

B₁=F [symbol] ₁ (32)

Most of the matrix B₁ is zero and is not required for operation. Therefore, the matrix may be reduced without loss of information through permutation and truncation, and this may be mathematically expressed as follows.

H=W_{T}B₁ (33)

Meanwhile, a method for removing the jump in the columns of the matrix by Equation (31) may be variously considered. The fact that the first row in the time domain is all zero has the same meaning that the sum for each column in the frequency domain is zero. Therefore, the method for removing the jump is not unique, but all of the methods for removing the jump are not useful. Whether or not the method for removing the jump is useful is determined by diversity capable of designating frequency characteristic and a pilot vector as described below.

A relationship between the initial matrix G₀ and an intermediate matrix H is as follows.

H=ΘG₀ (34)

Here, θ is used as an operator that removes the jump in the columns of the initial matrix G₀ to make the sum for the respective columns in the matrix H zero. This is mathematically expressed as follows.

I_{1×N}H=θ_{1×(N-1)} (35)

An important fact when devising the method for removing the jump is that a rank of the matrix from which the jump is removed should not be reduced as compared to an original rank.

First, for N, which is an even number, two N×(N−1) matrixes that satisfy Equation (35) may be defined as follows.

$$\begin{matrix}{R}_{e 1} = \frac{1}{\sqrt{2}} [ \begin{matrix} & & & & & & & 0 \\ & & & & & 0 & 1 & \\ & & & & ⋰ & & & \\ & & 0 & 1 & & & & \\ 0 & 1 & & & & & & \\ 0 & 1 & & & & & & \\ & & 0 & 1 & & & & \\ & & & & ⋱ & & & \\ & & & & & 0 & 1 & \\ & & & & & & & 0\end{matrix} ] & ( 36 a ) \\ {R}_{e 2} = \frac{1}{\sqrt{2}} [ \begin{matrix} & & & & & & & 0 \\ & & & & & 0 & 1 / 2 & \\ & & & & ⋰ & & 1 / 2 & \\ & & 0 & 1 / 2 & & & & \\ 0 & 1 & & 1 / 2 & & & & \\ 0 & 1 & & 1 / 2 & & & & \\ & & 0 & 1 / 2 & & & & \\ & & & & ⋱ & & 1 / 2 & \\ & & & & & 0 & 1 / 2 & \\ & & & & & & & 0\end{matrix} ] & ( 36 b )\end{matrix}$$

It may be seen that the sum of even-numbered columns of Equations (36a) and (36b) is all \sqrt{2}. If the jump matrix is subtracted from the initial matrix, a matrix from which the jump is removed may be obtained as follows.

$$\begin{matrix}{H}_{e 1} = {Θ}_{e 1} {G}_{e}^{( 0 )} = {G}_{e}^{( 0 )} - {R}_{e 1} = \frac{1}{\sqrt{2}} [ \begin{matrix} & & & & & & 1 \\ & & & & & 1 & - 1 \\ & & & 1 & ⋰ & & \\ & 1 & 1 & - 1 & & & \\ 1 & - 1 & & & & & \\ - 1 & - 1 & & & & & \\ & 1 & - 1 & - 1 & & & \\ & & & 1 & ⋱ & & \\ & & & & & - 1 & - 1 \\ & & & & & & 1\end{matrix} ] & ( 38 a ) \\ {H}_{e 2} = {Θ}_{e 2} {G}_{e}^{( 0 )} = {G}_{e}^{( 0 )} - {R}_{e 2} = \frac{1}{\sqrt{2}} [ \begin{matrix} & & & & & & 1 \\ & & & & & 1 & - 1 / 2 \\ & & & 1 & ⋰ & & - 1 / 2 \\ & 1 & 1 & - 1 / 2 & & & \\ 1 & - 1 & & - 1 / 2 & & & \\ - 1 & - 1 & & - 1 / 2 & & & \\ & 1 & - 1 & - 1 / 2 & & & \\ & & & 1 & ⋱ & & - 1 / 2 \\ & & & & & - 1 & - 1 / 2 \\ & & & & & & 1\end{matrix} ] & ( 38 b )\end{matrix}$$

It may be seen that the sum for columns of the above two matrixes is all zero. It may be seen from the above-mentioned fact that such a matrix becomes a matrix in which there is no jump in the time domain.

Next, for N, which is an odd number, two N×(N−1) matrixes that satisfy Equation (35) may be defined as follows.

$$\begin{matrix}{R}_{o 1} = \frac{1}{\sqrt{2}} [ \begin{matrix} & & & 0 & 0 \\ & & ⋰ & & \\ 0 & 0 & & & \\ 2 & 0 & ⋯ & 2 & 0 \\ 0 & 0 & ⋱ & & \\ & & & 0 & 0\end{matrix} ] & ( 39 a ) \\ {R}_{o 2} = \frac{1}{\sqrt{2}} [ \begin{matrix} & & & & 0.5 & 0 \\ & & & ⋰ & & \\ 0 & 0 & 0.5 & & & \\ 2 & 0 & 1 & ⋯ & 1 & 0 \\ 0 & 0 & 0.5 & ⋱ & & \\ & & & & & \\ & & & & 0.5 & 0\end{matrix} ] & ( 39 b )\end{matrix}$$

It may be seen that the sum of odd-numbered columns of Equations (39a) and (39b) is all \sqrt{2}. If the jump matrix is subtracted from the initial matrix, a matrix from which the jump is removed may be obtained as follows.

$$\begin{matrix}{H}_{o 1} = {Θ}_{o 1} {G}_{o}^{( 0 )} = {G}_{o}^{( 0 )} - {R}_{o 1} = \frac{1}{\sqrt{2}} [ \begin{matrix} & & & & & 1 & 1 \\ & & & & ⋰ & - 1 & \\ & & 1 & 1 & & & \\ 1 & 1 & - 1 & & & & \\ - 2 & 0 & & & ⋯ & & 0 \\ 1 & - 1 & - 1 & & & & \\ & & 1 & - 1 & & & \\ & & & & ⋱ & - 1 & \\ & & & & & 1 & - 1\end{matrix} ] & ( 40 a ) \\ {H}_{o 2} = {Θ}_{o 2} {G}_{o}^{( 0 )} = {G}_{o}^{( 0 )} - {R}_{o 2} = \frac{1}{\sqrt{2}} [ \begin{matrix} & & & & & 1 & 1 \\ & & & & ⋰ & - 0.5 & \\ & & 1 & 1 & & & \\ 1 & 1 & - 0.5 & & & & \\ - 2 & 0 & - 1 & & ⋯ & - 1 & 0 \\ 1 & - 1 & - 0.5 & & & & \\ & & 1 & - 1 & & & \\ & & & & ⋱ & - 0.5 & \\ & & & & & 1 & - 1\end{matrix} ] & ( 40 b )\end{matrix}$$

It may be seen that the sum for columns of the above two matrixes is all zero. It may be seen from the above-mentioned fact that such a matrix becomes a matrix in which there is no jump in the time domain.

Now, in order to improve spectrum characteristic of the matrix from which the jump is removed, a filtering is performed. This is mathematically expressed as follows.

[symbol]

₁=ΨF⁻¹WH (41)

Here, Ψ is expressed as in Equation (42).

$$Ψ = \frac{1}{2} [ \begin{matrix}1 & 1 & & & & & \\ & 1 & 1 & & & & \\ & & 1 & 1 & & & \\ & & & & ⋱ & & \\ & & & & & 1 & 1 \\ & & & & & & 1\end{matrix} ] \qquad ( 42 )$$

After performing the filtering, DFT, permutation, and truncation, the filtered matrix as follows may be obtained.

U=WF [symbol] ₁=ΩH=ΩΘG₀ (43)

The initial matrix is started with the matrix having orthogonal columns, but may be deviated from the matrix having the orthogonal columns while removing the jump and performing the filtering. Therefore, the matrix given by Equation (43) may be transformed to a matrix having the closest orthogonal column while maintaining property thereof, as follows.

$$G = {U ( {U}^{H} U )}^{- \frac{1}{2}} \qquad ( 44 )$$

Here, U^{H} is the Hermitian matrix of U. By so doing, it was shown that G is generated from G₀ by Equation (22).

A communication path between the transmitter and the receiver may have a plurality of channel paths. In order to obtain information on the paths, an existing OFDM uses pre-known pilot symbol between the transmitter and the receiver. G-OFDM does not use one subchannel, but uses one column in the matrix as a pilot vector.

A process of generating the matrix including the pilot vector may be defined in the same way as the process of generating G from the initial matrix G₀. In the matrix including the pilot vector, all other vector elements corresponding to the rows that are located in non-zero elements that make up the pilot vector should be all be zero.

N When N is an even number, the initial matrix may be defined as follows.

$${G}_{p , e}^{( 0 )} = \frac{1}{\sqrt{2}} [ \begin{matrix} & & & & & 1 & 1 \\ & & & & ⋰ & & \\ & & 1 & 1 & & & \\ & 1 & & & & & \\ 1 & & & & & & \\ - 1 & & & & & & \\ & - 1 & & & & & \\ & & 1 & - 1 & & & \\ & & & & ⋱ & & \\ & & & & & 1 & - 1\end{matrix} ] \qquad ( 45 )$$

In addition, jump matrixes may be defined as follows.

$$\begin{matrix}{R}_{p , e 1} = \frac{1}{\sqrt{2}} [ \begin{matrix} & & & & & & 0 \\ & & & & 0 & 1 & \\ & & & ⋰ & & & \\ & 0 & 1 & & & & \\ 0 & & & & & & \\ 0 & & & & & & \\ & 0 & 1 & & & & \\ & & & ⋱ & & & \\ & & & & 0 & 1 & \\ & & & & & & 0\end{matrix} ] & ( 46 a ) \\ {R}_{e 2 , p} = \frac{1}{\sqrt{2}} [ \begin{matrix} & & & & & & 0 \\ & & & & 0 & 1 / 2 & \\ & & & ⋰ & & 1 / 2 & \\ & 0 & 1 / 2 & & & & \\ 0 & & 1 / 2 & & & & \\ 0 & & 1 / 2 & & & & \\ & 0 & 1 / 2 & & & & \\ & & & ⋱ & & 1 / 2 & \\ & & & & 0 & 1 / 2 & \\ & & & & & & 0\end{matrix} ] & ( 46 b )\end{matrix}$$

N When N is an odd number, the initial matrix may be defined as follows.

$$\begin{matrix}{G}_{p , o}^{( 0 )} = \frac{1}{\sqrt{2}} [ \begin{matrix} & & & & 1 & 1 \\ & & & ⋰ & & \\ & 1 & 1 & & & \\ 1 & & & & & \\ 0 & & & ⋯ & 0 & 0 \\ - 1 & & & & & \\ & 1 & - 1 & & & \\ & & & ⋱ & & \\ & & & & 1 & - 1\end{matrix} ] & \end{matrix} \qquad ( 47 )$$

In addition, jump matrixes may be defined as follows.

$$\begin{matrix}{R}_{p , o 1} = \frac{1}{\sqrt{2}} [ \begin{matrix} & & & & 0 & 0 \\ & & & ⋰ & & \\ & & & & & \\ 0 & 2 & 0 & ⋯ & 2 & 0 \\ & & & & & \\ & & & ⋱ & & \\ & & & & 0 & 0\end{matrix} ] & ( 48 a ) \\ {R}_{p , o 2} = \frac{1}{\sqrt{2}} [ \begin{matrix} & & & & 0.5 & 0 \\ & & & ⋰ & & \\ & & 0 & & & \\ 0 & 0.5 & & & & \\ 0 & 1 & & ⋯ & 1 & 0 \\ 0 & 0.5 & & & & \\ & & 0 & & & \\ & & & ⋱ & & \\ & & & & 0.5 & 0\end{matrix} ] & ( 48 b )\end{matrix}$$

### Simulation and Result

In order to confirm whether or not the frequency cut-off characteristic is well made when the filter matrix, which is a key of the present invention, is actually applied, a simulation was performed. That is, a simulation process will be briefly described below. The matrix of the hierarchical function is obtained using the initial matrix which is appropriately set, the jump matrix, and Equation (22), and it is confirmed whether a first column of the matrix of the hierarchical function may be used as the pilot vector. In general, a reference signal known to both the transmitter and the receiver for channel estimation is called a pilot, and if the first column of the matrix of the hierarchical function obtained in the simulation satisfies the conditions described above, it may be determined that the first column of the matrix of the hierarchical function has high frequency cut-off characteristic and may be used as the pilot vector.

### Inventive Example 1: G(8,6)-OFDM

First, G_{p,e1}^{(8×6)}=G_{p,e1,real}^{(8×6)}+jG_{p,e1,imag}^{(8×6)} may be obtained from Equation (22) with an initial matrix Gₚ^{(0)(8×6)} and a jump matrix R_{p,e1}^{(8×6)}. Here, G_{p,e1,real}^{(8×6)} and G_{p,e1,imag}^{(8×6)} are shown in Tables 1(a) and 1(b), respectively. Referring to Tables 1(a) and 1(b), when it is assumed that a first column is a pilot vector, all elements of other vectors become zero for element other than first zero, and as a result, it may be seen that the first column may be used as the pilot vector.

TABLE 1(a)

| | | | | | |
|---|---|---|---|---|---|
| 0.0000 | 0.0000 | 0.1494 | 0.0000 | 0.5577 | 0.7071 |
| 0.0000 | 0.0000 | 0.4082 | 0.7071 | −0.4083 | 0.0000 |
| 0.0000 | 0.7071 | −0.5577 | 0.0000 | −0.1494 | 0.0000 |
| 0.7071 | 0.0000 | 0.0000 | 0.0000 | 0.0000 | 0.0000 |
| −0.7070 | 0.0000 | 0.0000 | 0.0000 | 0.0000 | 0.0000 |
| 0.0000 | −0.7070 | −0.5576 | 0.0000 | −0.1494 | 0.0000 |
| 0.0000 | 0.0000 | 0.4082 | −0.7070 | −0.4082 | 0.0000 |
| 0.0000 | 0.0000 | 0.1494 | 0.0000 | 0.5575 | −0.7069 |

TABLE 1(b)

| | | | | | |
|---|---|---|---|---|---|
| 0.0000 | 0.0000 | 0.0000 | 0.0000 | 0.0000 | 0.0000 |
| 0.0000 | 0.0000 | 0.0013 | 0.0022 | −0.0013 | 0.0000 |
| 0.0000 | 0.0043 | −0.0034 | 0.0000 | −0.0009 | 0.0000 |
| 0.0065 | 0.0000 | 0.0000 | 0.0000 | 0.0000 | 0.0000 |
| −0.0087 | 0.0000 | 0.0000 | 0.0000 | 0.0000 | 0.0000 |
| 0.0000 | −0.0108 | −0.0086 | 0.0000 | −0.0023 | 0.0000 |
| 0.0000 | 0.0000 | 0.0075 | −0.0130 | −0.0075 | 0.0000 |
| 0.0000 | 0.0000 | 0.0032 | 0.0000 | 0.0120 | −0.0152 |

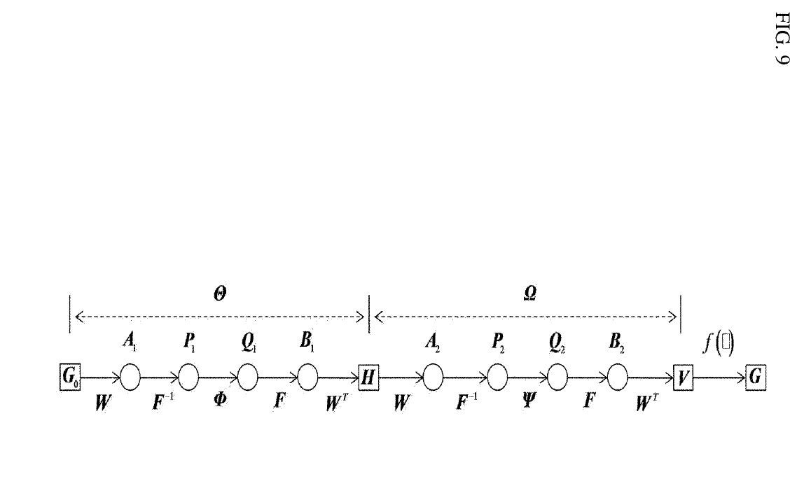

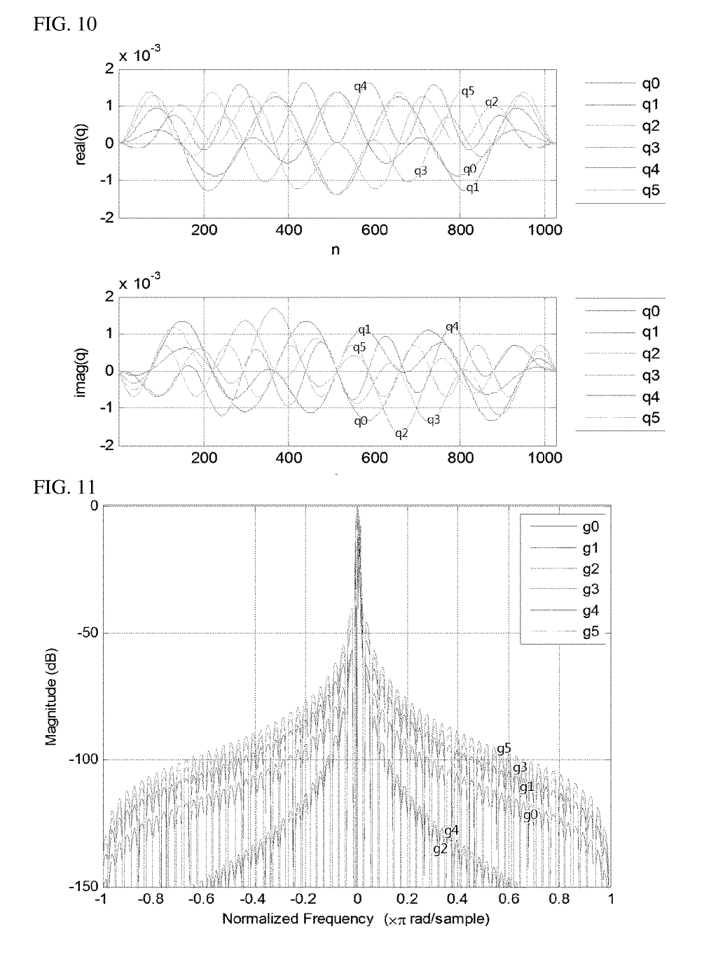

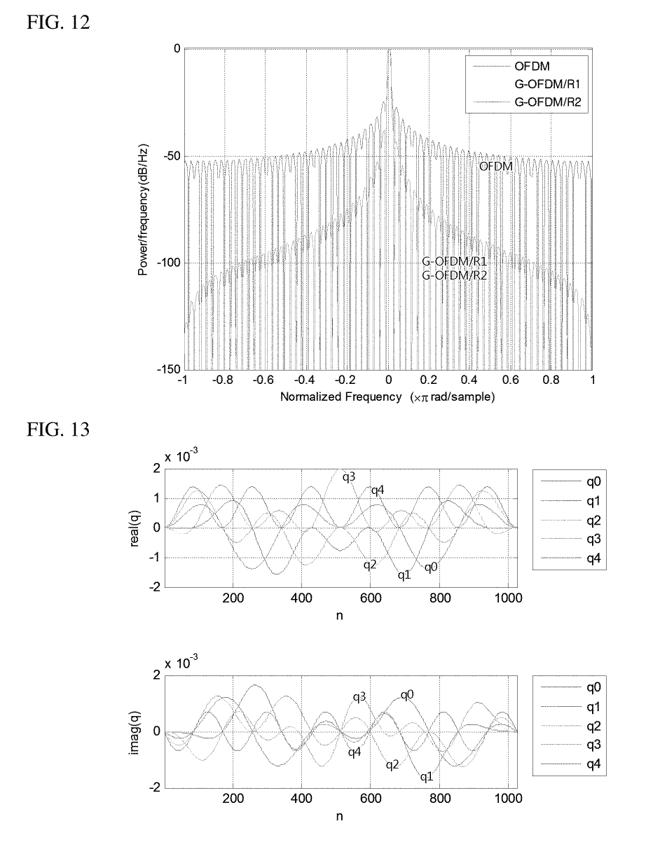

FIG. 10 shows columns of the matrix G^{(8×6)} in the time domain, and it may be seen that all curves start with 0 and end at 0. This prevents a spectrum spread by not sharply changing a function used as a carrier wave. FIG. 11 shows the columns of the matrix G in the frequency domain, and it may be seen that spectrum characteristics are different for each of the columns. FIG. 12 illustrates a comparison between existing OFDM and power spectral density (PSD) of G-OFDM according to the present invention. It may be confirmed from FIG. 12 that G-OFDM shows very high spectrum use efficiency.

Meanwhile, G_{p,e2}^{(8×6)}=G_{p,e2,real}^{(8×6)}+jG_{p,e2,imag}^{(8×6)} may be obtained from Equation (22) with an initial matrix Gₚ^{(0)(8×6)} and a jump matrix R_{p,e2}^{(8×6)}. Here, G_{p,e2,real}^{(8×6)} and G_{p,e2,imag}^{(8×6)} are shown in Tables 2(a) and 2(b), respectively. Referring to Tables 2(a) and 2(b), when it is assumed that a first column is a pilot vector, all elements of other vectors are not zero for elements other than first zero, and as a result, it may be seen that the first column may not be used as the pilot vector.

TABLE 2(a)

| | | | | | |
|---|---|---|---|---|---|
| 0.0000 | 0.0000 | 0.0490 | 0.0000 | 0.5835 | 0.7071 |
| 0.0000 | 0.0000 | 0.5590 | 0.7071 | −0.2428 | 0.0000 |
| 0.0000 | 0.7071 | −0.3162 | 0.0000 | −0.3162 | 0.0000 |
| 0.7071 | 0.0000 | −0.2917 | 0.0000 | −0.0245 | 0.0000 |
| −0.7070 | 0.0000 | −0.2917 | 0.0000 | −0.0245 | 0.0000 |
| 0.0000 | −0.7070 | −0.3162 | 0.0000 | −0.3162 | 0.0000 |
| 0.0000 | 0.0000 | 0.5589 | −0.7070 | −0.2427 | 0.0000 |
| 0.0000 | 0.0000 | 0.0490 | 0.0000 | 0.5833 | −0.7069 |

TABLE 2(b)

| | | | | | |
|---|---|---|---|---|---|
| 0.0000 | 0.0000 | 0.0000 | 0.0000 | 0.0000 | 0.0000 |
| 0.0000 | 0.0000 | 0.0017 | 0.0022 | −0.0007 | 0.0000 |
| 0.0000 | 0.0043 | −0.0019 | 0.0000 | −0.0019 | 0.0000 |
| 0.0065 | 0.0000 | −0.0027 | 0.0000 | −0.0002 | 0.0000 |
| −0.0087 | 0.0000 | −0.0036 | 0.0000 | −0.0003 | 0.0000 |
| 0.0000 | −0.0108 | −0.0049 | 0.0000 | −0.0049 | 0.0000 |
| 0.0000 | 0.0000 | 0.0103 | −0.0130 | −0.0045 | 0.0000 |
| 0.0000 | 0.0000 | 0.0011 | 0.0000 | 0.0125 | −0.0152 |

### Inventive Example 2: G(7,5)-OFDM

First, G_{p,o1}^{(7×5)}=G_{p,o1,real}^{(7×5)}+jG_{p,o1,imag}^{(7×5)} may be obtained from Equation (22) with an initial matrix Gₚ^{(0)(7×5)} and a jump matrix R_{p,o1}^{(7×5)}. Here, G_{p,o1,real}^{(7×5)} and G_{p,o1,imag}^{(7×5)} are shown in Tables 3(a) and 3(b), respectively. Referring to Tables 3(a) and 3(b), when it is assumed that a first column is a pilot vector, all elements of other vectors become zero for element other than first zero, and as a result, it may be seen that the first column may be used as the pilot vector.

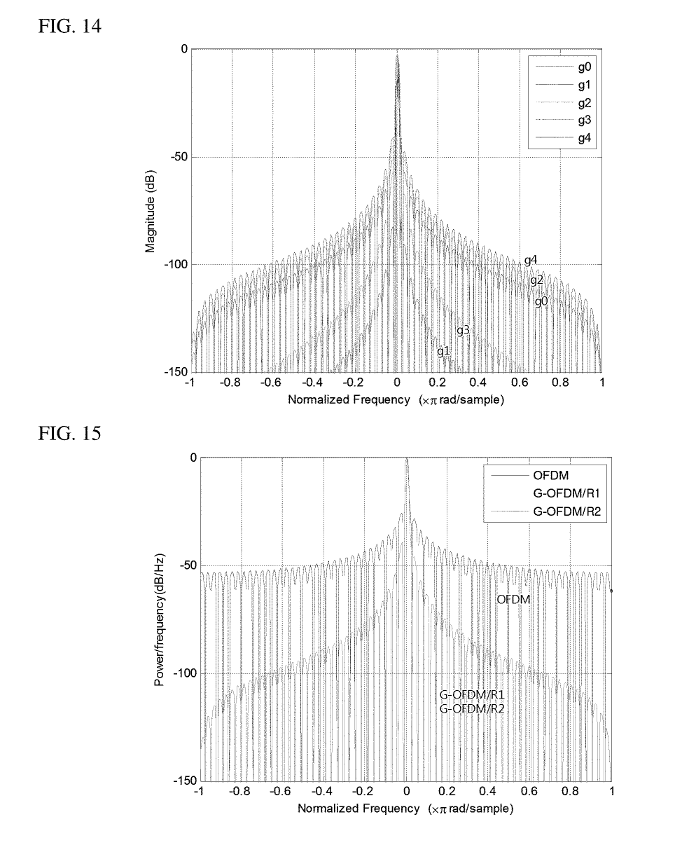

FIG. 13 shows columns of the matrix G^{(7×5)} in the time domain, and it may be seen that all curves start with 0 and end at 0. This prevents a spectrum spread by not sharply changing a function used as a carrier wave. FIG. 14 shows the columns of the matrix G in the frequency domain, and it may be seen that spectrum characteristics are different for each of the columns. FIG. 15 illustrates a comparison between existing OFDM and power spectral density (PSD) of G-OFDM according to the present invention. It may be confirmed from FIG. 15 that G-OFDM shows very high spectrum use efficiency.

TABLE 3(a)

| | | | | |
|---|---|---|---|---|
| 0.0000 | −0.1954 | 0.0000 | 0.5117 | 0.7071 |
| 0.0000 | 0.5117 | 0.7071 | −0.1954 | 0.0000 |
| 0.7071 | 0.0000 | 0.0000 | 0.0000 | 0.0000 |
| 0.0000 | −0.6324 | 0.0000 | −0.6324 | 0.0000 |
| −0.7070 | 0.0000 | 0.0000 | 0.0000 | 0.0000 |
| 0.0000 | 0.5116 | −0.7070 | −0.1954 | 0.0000 |
| 0.0000 | −0.1954 | 0.0000 | 0.5116 | −0.7070 |

TABLE 3(b)

| | | | | |
|---|---|---|---|---|
| 0.0000 | 0.0000 | 0.0000 | 0.0000 | 0.0000 |
| 0.0000 | 0.0016 | 0.0022 | −0.0006 | 0.0000 |
| 0.0043 | 0.0000 | 0.0000 | 0.0000 | 0.0000 |
| 0.0000 | −0.0058 | 0.0000 | −0.0058 | 0.0000 |
| −0.0087 | 0.0000 | 0.0000 | 0.0000 | 0.0000 |
| 0.0000 | 0.0078 | −0.0108 | −0.0030 | 0.0000 |
| 0.0000 | −0.0036 | 0.0000 | 0.0094 | −0.0130 |

Meanwhile, G_{p,o2}^{(7×5)}=G_{p,o2,real}^{(7×5)}+jG_{p,o2,imag}^{(7×5)} may be obtained from Equation (22) with an initial matrix Gₚ^{(0)(7×5)} and a jump matrix R_{p,o2}^{(7×5)}. Here, G_{p,o2,real}^{(7×5)} and G_{p,o2,imag}^{(7×5)} a are shown in Tables 4(a) and 4(b), respectively. Referring to Tables 4(a) and 4(b), when it is assumed that a first column is a pilot vector, all elements of other vectors are not zero for elements other than first zero, and as a result, it may be seen that the first column may not be used as the pilot vector.

TABLE 4(a)

| | | | | |
|---|---|---|---|---|
| 0.0000 | 0.0435 | 0.0000 | 0.5827 | 0.7071 |
| 0.0000 | 0.5175 | 0.7071 | −0.2479 | 0.0000 |
| 0.7071 | −0.2914 | 0.0000 | −0.3131 | 0.0000 |
| 0.0000 | −0.5392 | 0.0000 | −0.0435 | 0.0000 |
| −0.7070 | −0.2913 | 0.0000 | −0.3131 | 0.0000 |
| 0.0000 | 0.5174 | −0.7070 | −0.2479 | 0.0000 |
| 0.0000 | 0.0435 | 0.0000 | 0.5826 | −0.7070 |

TABLE 4(b)

| | | | | |
|---|---|---|---|---|
| 0.0000 | 0.0000 | 0.0000 | 0.0000 | 0.0000 |
| 0.0000 | 0.0016 | 0.0022 | −0.0008 | 0.0000 |
| 0.0043 | −0.0018 | 0.0000 | −0.0019 | 0.0000 |
| 0.0000 | −0.0050 | 0.0000 | −0.0004 | 0.0000 |
| −0.0087 | −0.0036 | 0.0000 | −0.0038 | 0.0000 |
| 0.0000 | 0.0079 | −0.0108 | −0.0038 | 0.0000 |
| 0.0000 | 0.0008 | 0.0000 | 0.0107 | −0.0130 |

From the above simulation results, it was confirmed that a technology capable of simultaneously controlling orthogonality and the spectrum by the method for generating G from G₀ according to the present invention is developed. It is also confirmed that the matrix for implementing the system is not unique, but the useful matrixes are matrixes capable of accommodating the pilot vector when R_{p,e1} and R_{p,o1}, which are the proposed jump matrixes, are used.

The present invention is not limited to the above-mentioned exemplary embodiments but may be variously applied, and may be variously modified by those skilled in the art to which the present invention pertains without departing from the gist of the present invention claimed in the claims.

### INDUSTRIAL APPLICABILITY

According to the present invention, since the existing frequency interference problem may be perfectly solved by using the G-OFDM technology, the G-OFDM technology is expected to be a very useful technology for the next generation communication technology as well as the fifth generation.

1. A communication method using generalized orthogonal frequency division multiplexing (G-OFDM), wherein a plurality of hierarchical channels defined as predetermined frequency bands are present and digital data is carried in each of the hierarchical channels,
the plurality of hierarchical channels are overlapped and multiplexed by a plurality of hierarchical composite functions that each correspond to the plurality of hierarchical channels, the plurality of hierarchical composite functions are defined as functions in a frequency domain and have orthogonality and frequency cut-off characteristic, such that transmission and reception are performed, and
each of the hierarchical channel is divided into a plurality of subchannels.

2. The communication method of claim 1, wherein the respective frequency bands of the plurality of subchannels formed for each of the hierarchical channels are formed to be equal to each other for all hierarchical channels.

3. The communication method of claim 1, wherein when it is assumed that a matrix including the plurality of hierarchical composite functions is a composite matrix and a matrix including hierarchical split functions that each correspond to the plurality of hierarchical composite functions is a split matrix, the composite matrix and the split matrix are represented by a hierarchical function matrix G having the same structure, and
the hierarchical function matrix G is formed so that G^{T}G=I is established.

4. The communication method of claim 3, wherein the obtaining of the hierarchical function matrix G includes:
determining an initial matrix G₀ as a matrix having a length of a column of 1 and having orthogonality between columns;
multiplying a jump removal matrix θ with the initial matrix G₀ to have frequency cut-off characteristic by preventing an occurrence of a spectrum spreading or leakage phenomenon due to a jump at a start point, wherein the jump removal matrix performing an operation of subtracting a first row from each row;
multiplying a filtering matrix Ω with a product θG₀ of the jump removal matrix θ and the initial matrix G₀ to perform a column smoothing; and
generating the hierarchical function matrix G by transforming a product ΩθG₀ of the filtering matrix Ω, the jump removal matrix θ, and the initial matrix G₀ by a transformation function
$$( f ( x ) = {X ( {X}^{H} X )}^{- \frac{1}{2}} )$$
to re-secure orthogonality.

5. The communication method of claim 4, wherein a first column of a hierarchical function matrix G_{p,e1} generated with an initial matrix G_{p,e}⁽⁰⁾ and a jump matrix R_{p,e1} that have a length of an even-numbered column, or a hierarchical function matrix G_{p,o1} generated with an initial matrix G_{p,o}⁽⁰⁾ and a jump matrix R_{p,o1} that have a length of an odd-numbered column is used as a pilot vector,
wherein the initial matrix G_{p,o}⁽⁰⁾ having the length of the even-numbered column is defined as
$${G}_{p , e}^{( 0 )} = \frac{1}{\sqrt{2}} [ \begin{matrix} & & & & & 1 & 1 \\ & & & & ⋰ & & \\ & & 1 & 1 & & & \\ & 1 & & & & & \\ 1 & & & & & & \\ - 1 & & & & & & \\ & - 1 & & & & & \\ & & 1 & - 1 & & & \\ & & & & ⋱ & & \\ & & & & & 1 & - 1\end{matrix} ] , \\ {R}_{p , e 1} = \frac{1}{\sqrt{2}} [ \begin{matrix} & & & & & & 0 \\ & & & & 0 & 1 & \\ & & & ⋰ & & & \\ & 0 & 1 & & & & \\ 0 & & & & & & \\ 0 & & & & & & \\ & 0 & 1 & & & & \\ & & & ⋱ & & & \\ & & & & 0 & 1 & \\ & & & & & & 0\end{matrix} ] , \\ {G}_{p , o}^{( 0 )} = \frac{1}{\sqrt{2}} [ \begin{matrix} & & & & 1 & 1 \\ & & & ⋰ & & \\ & 1 & 1 & & & \\ 1 & & & & & \\ 0 & & & ⋯ & 0 & 0 \\ - 1 & & & & & \\ & 1 & - 1 & & & \\ & & & ⋱ & & \\ & & & & 1 & - 1\end{matrix} ]$$
$${R}_{p , o 1} = \frac{1}{\sqrt{2}} [ \begin{matrix} & & & & 0 & 0 \\ & & & ⋰ & & \\ & & & & & \\ 0 & 2 & 0 & ⋯ & 2 & 0 \\ & & & & & \\ & & & ⋱ & & \\ & & & & 0 & 0\end{matrix} ] .$$
the jump matrix R_{p,e1} having the length of the even-numbered column is defined as
$${R}_{p , e 1} = \frac{1}{\sqrt{2}} [ \begin{matrix} & & & & & & 0 \\ & & & & 0 & 1 & \\ & & & ⋰ & & & \\ & 0 & 1 & & & & \\ 0 & & & & & & \\ 0 & & & & & & \\ & 0 & 1 & & & & \\ & & & ⋱ & & & \\ & & & & 0 & 1 & \\ & & & & & & 0\end{matrix} ] ,$$
the initial matrix G_{p,o}⁽⁰⁾ having the length of the odd-numbered column is defined as
$${G}_{p , o}^{( 0 )} = \frac{1}{\sqrt{2}} [ \begin{matrix} & & & & 1 & 1 \\ & & & ⋰ & & \\ & 1 & 1 & & & \\ 1 & & & & & \\ 0 & & & ⋯ & 0 & 0 \\ - 1 & & & & & \\ & 1 & - 1 & & & \\ & & & ⋱ & & \\ & & & & 1 & - 1\end{matrix} ] ,$$
and
the jump matrix R_{p,e1} having the length of the odd-numbered column is defined as
$${R}_{p , o 1} = \frac{1}{\sqrt{2}} [ \begin{matrix} & & & & 0 & 0 \\ & & & ⋰ & & \\ & & & & & \\ 0 & 2 & 0 & ⋯ & 2 & 0 \\ & & & & & \\ & & & ⋱ & & \\ & & & & 0 & 0\end{matrix} ] .$$

6. The communication method of claim 1, wherein the communication method includes overlapping and transmitting frequencies in which data consisting of digital signals is converted into an analog signal and is transmitted through the plurality of hierarchical channels, and the data carried in the hierarchical channels is overlapped in the frequency domain using the hierarchical composite functions and is converted into a time domain signal and is then transmitted to one communication channel; and
splitting and receiving the frequency in which the data of a form of the analog signal transmitted by the overlapping and transmitting of the frequencies is received and is converted to the frequency domain signal from a time domain signal, and the data consisting of the digital signals carried in each of the hierarchical channels is split and restored using hierarchical split functions corresponding to the hierarchical composite functions.

7. The communication method of claim 1, wherein the communication method uses one modulation scheme selected from BPSK, QPSK, M-PSK, and M-QAM (where M=2^{N}, N=1, 2, 3, . . . ) when the data is carried in each of the subchannels, and
the modulation schemes used for each of the hierarchical channels are the same as or different from each other.

8. A communication apparatus using G-OFDM performing communication using the communication method wherein a plurality of hierarchical channels defined as predetermined frequency bands are present and digital data is carried in each of the hierarchical channels, the method comprising:
overlapping and multiplexing the plurality of hierarchical channels using a plurality of hierarchical composite functions that each correspond to the plurality of hierarchical channels, the plurality of hierarchical composite functions are defined as functions in a frequency domain and have orthogonality and frequency cut-off characteristic, such that transmission and reception are performed; and
each of the hierarchical channel is divided into a plurality of subchannels.
